(19) United States
(12) Patent Application Publication
(10) Pub. No.: US 2012/0004824 A1
(43) Pub. Date: Jan. 5, 2012

(54) NATURAL GAS AND DIESEL FUEL BLENDING SYSTEM

(76) Inventors: Trevor Robert Milton, St. George, UT (US); Michael David Shrout, St. George, UT (US)

(21) Appl. No.: 12/957,342

(22) Filed: Nov. 30, 2010

Related U.S. Application Data
(60) Provisional application No. 61/265,279, filed on Nov. 30, 2009.

(51) Int. Cl. F02D 41/30

(52) U.S. Cl. 701/103

(57) ABSTRACT

An electronically controlled fuel blending system that injects compressed natural gas into the air intake of a diesel engine resulting in lower emissions, increased fuel economy is disclosed.

### CROSS-REFERENCE TO RELATED APPLICATIONS

This application claims the benefit of U.S. Provisional Application No. 61/265,279, filed Nov. 30, 2009, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

The disclosure relates generally to vehicle engines and more specifically, but not necessarily entirely, to engines that may be operated at high specific output, such as turbo charged or supercharged diesel and gasoline engines.

### SUMMARY OF THE DISCLOSURE

An electronically controlled fuel blending system that injects compressed natural gas into the air intake of a diesel engine resulting in lower emissions, increased fuel economy, and air fuel ration is disclosed. Air fuel ratios may be monitored and adjusted by a CPU (Central Processing Unit) and may be monitored by a user on a visual display, which outputs the monitored vital engine functions such as: fuel usage, fuel ratio, actual mileage in real time, fuel levels, fuel flow rates, altitude adjustments, GPS position and comparison of fuel consumption. The CPU may also monitor the current cost of fuel per mile per gallon at current speeds and conditions, allowing drivers to adjust driving habits to reduce fuel consumption and emission levels.

The system may use standard 3600 PSI natural gas and is capable of using up to 5000 PSI natural gas levels. These pressure levels may be controlled by a high pressure reducer, which takes the natural gas pressure levels from a high level of 3600-5000 PSI to less than 100 PSI, thereby allowing air to efficiently mix with the natural gas and provide optimal fuel hybrid mixtures.

The system may comprise a pressure reducer with an integrated heating element (12V) to eliminate: (1) icing and freezing problems; (2) formation of condensation; and (3) formation of methane from the reduction in pressure of natural gas.

The system may also comprise an electronically controlled valve, which may comprise a stepper motor actuated valve that has electronically controlled variable valve opening sizes.

The system may also comprise a natural gas nozzle assembly, which may be built as a one piece unit that replaces a short section of an air flexible air intake or may be placed in line with an air intake of an engine.

The system may also comprise a mass air flow sensor that monitors air flow and volume on the fly during use. This sensor may produce a 0-5 analog signal, which is sent to the CPU to adjust the air to gas mixture levels produced by the injection nozzle on the fly during use.

The system may also comprise an air temperature sensor that may work in conjunction with the mass air flow sensor to enable the CPU to accurately measure actual air volume entering the engine and to adjust temperature on the fly to keep efficiency levels as high as possible.

The system may also comprise a pressure sensor that may be installed on the air intake, downstream from a turbo charger. This sensor may be used to help the CPU calculate the optimum air fuel ratio.

The system may also comprise a diesel fuel flow meter that may be used to determine the diesel consumption in real time. The diesel fuel flow meter may send the CPU data that allows the display screen to display the diesel consumption that assists in the cost per mile calculation and the miles per gallon (or kilometers per liter) cost calculation displayed on the screen. That data and information may be transmitted to a computer system allowing fleet management to assist drivers in adjusting driving habits. Such data may be networked wherein a control base and fleet members form a network wherein data is exchanged in order to maximize certain parameters.

The natural gas/diesel injection system, bi-fuel, hybrid, mixing system, fuel enhancement, emission control device, may enhance combustion and fumigation. The system may incorporate a fuel metering system and fuel blending system that improves efficiency and reduces diesel fuel consumption.

The system may also comprise the components of an electronic control unit with a display screen, a regulator, a natural gas injection nozzle assembly, and multiple sensors for monitoring conditions and operation during use of the system.

The system may be microprocessor controlled, wherein current conditions may be displayed to a user on the fly during use such as natural gas and diesel fuel levels, natural gas/diesel ratio being used, current mileage MPG (separate and combined), fuel consumption maybe monitored and adjusted constantly and automatically within the bounds of the system components. The system may optimize natural gas usage, which reduces diesel consumption for the same relative and proportional power output, resulting in lower fuel costs, lower emissions, and increased power.

The system may use multiple sensors to gather input on vital engine conditions such as a mass airflow sensor allowing the system to precisely adjust for optimum air to natural gas ratio, which results in a dramatic reduction in diesel consumption. Exhaust gas temperature, temperature, pressure, natural gas flow meter, diesel flow meter, natural gas pressure sensor, are also used for the optimization method.

The system may be integrated with a vehicle's on-board computer system and may automatically adjust according to current conditions experienced by the vehicle. The driver of the vehicle may also be able to manually override certain system functions if needed.

The natural gas system maybe designed to operate within a range of 3600 PSI to 5000 PSI or higher in order to accommodate the amount of fuel desired, and to provide the vehicle with the fuel needed to travel reasonable distances between fill-ups.

### BRIEF DESCRIPTION OF THE DRAWINGS

The features and advantages of the disclosure will become apparent from a consideration of the subsequent detailed description presented in connection with the accompanying drawings in which:

FIG. 1 is a schematic view of an embodiment of the disclosure;

FIG. 2 is a schematic view of an embodiment of the disclosure;

FIG. 3 is an illustrative embodiment of a natural gas injection system in accordance with the principles of the disclosure;

FIG. 4 is a system and network for monitoring resource usage in accordance with the principles of the disclosure;

FIG. 5 is a schematic view of an embodiment of the disclosure in accordance with the principles of the disclosure;

FIG. 6 is a schematic view of an embodiment of the disclosure illustrating a single natural gas injector in accordance with the principles of the disclosure;

FIG. 7 is a schematic view of an embodiment of the disclosure illustrating a plurality of natural gas injectors in accordance with the principles of the disclosure;

FIG. 8 is a schematic view of an embodiment of the disclosure illustrating a single controller in accordance with the principles of the disclosure;

FIG. 9 illustrates a graphical representation of natural gas injection in accordance with the principles of the disclosure;

FIG. 10 illustrates a graphical representation of natural gas injection in accordance with the principles of the disclosure;

FIG. 11 illustrates a graphical representation of natural gas injection in accordance with the principles of the disclosure;

FIG. 12 illustrates a method of natural gas injection in accordance with the principles of the disclosure; and

FIG. 13 illustrates a hardware schematic of natural gas injection in accordance with the principles of the disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

Before the digital closed loop natural gas and diesel hybrid fuel blending systems and methods are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the disclosure will be limited only by the patent claims and equivalents thereof.

It must be noted that, as used in this specification and appended claims, if any, the singular forms “a,” “an,” and “the” include plural referents unless the context clearly dictates otherwise.

In describing and claiming the subject matter of the disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

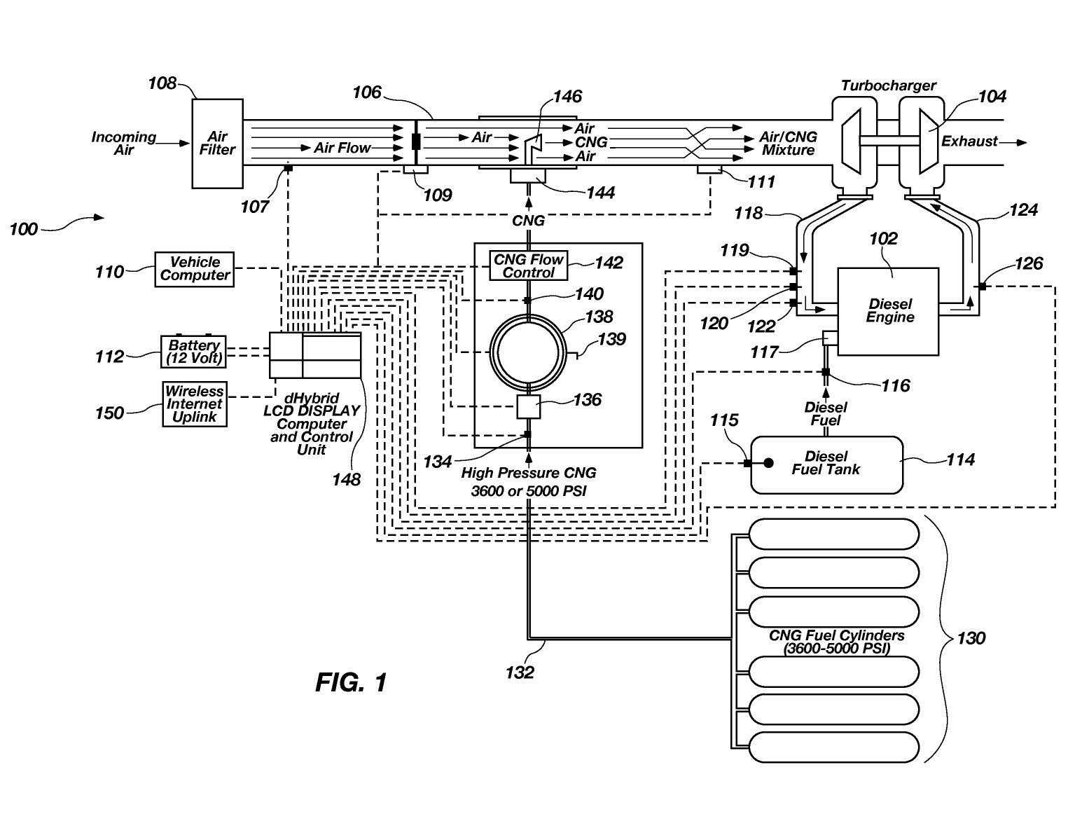

With reference primarily to FIG. 1, a system 100 for fueling an engine with a fuel comprising diesel and natural gas will be discussed. The system 100 may comprise an engine 102 as a primary component. The engine 102 may be of diesel configuration as is well known in the art and may further comprise a turbo charger 104 for suppling the engine 102 with improved combustibles. An air intake 106 may be incorporated to provide air into the system 100 and may have an air filter 108 attached thereto. The air intake 106 may also comprise an air temperature sensor 107 for sensing the temperature of the air going into the system thereby assisting the system in determine the density of the air. The air intake 106 may comprise a mass air flow sensor 109 for sensing the mass of the air flowing into the system 100. The air take intake 106 may comprise a mass air flow sensor 111 located between a natural gas injector assembly 144 and the turbo charger 104 to provide additional data to a computer 110. The system 100 may further comprise the computer 110 for processing data from said sensors. The system 100 may comprise a battery 112 for suppling electrical power to components of the system 100 that rely on electrical power in order to operate within the system 100. The system 100 may comprise a fuel tank 114 for holding fuel for powering the engine 102. The fuel tank 114 may comprise a fuel level sensor 115 for sensing the level of the fuel in the fuel tank 114 and may be configured for communicating fuel data to the computer 110. The system 100 may further comprise a diesel fuel flow sensor 116 that senses the flow volume of diesel fuel into the engine 102. Engine 102 may use an injection process to inject diesel fuel into the engine 102 by way of a diesel fuel injection pump 117.

The turbo charger 104 may interface with the engine 102 through an inlet channel 118 that has been configured to facilitate the movement of fluids (gas or liquid) into the engine 102. The inlet channel 118 may comprise a temperature sensor 119 for sensing the temperature of the air in the inlet channel and reporting the resultant data to the computer 110. The inlet channel 118 may comprise a pressure sensor 120 for sensing the pressure of the fluid mixture in the inlet channel 118. The inlet channel 118 may comprise a pressure switch 122 configured to control the pressure of the fluids in the inlet channel 118 so as to allow control of the fluids in the inlet channel 118 as it enters the engine 102.

After the engine 102 has consumed the chemical energy of the fuel air mixture entering the engine 102 by way of the inlet channel 118, exhaust gasses enter an outlet channel 124. The outlet channel 124 may comprise an exhaust temperature sensor 126. The outlet channel 124 channels the exhaust fluids into the turbo charger 104 to actuate the working elements of a turbo charger as is well known in the art.

The system 100 may further comprise natural gas fuel tanks 130. A single natural gas fuel tank may be used or a bank or array of fuel tanks may be used. The tanks 130 may be pressurized in a range from about 2500 psi to about 7000 psi. It will be appreciated that tanks containing pressures outside that range may also be used by the disclosure and it is within the scope of this disclosure to contemplate tanks pressurized to far higher pressures or far lower pressures than provided in the above range. The pressures of the tanks 130 within the system 100 are generally pressurized such that the pressure differential between the operating pressure of the system and the pressure in the tank or tanks causes natural gas to flow from the tanks 130 to the system 100. Accordingly any pressure or means for facilitating flow from tanks into an engine system is within the scope of this disclosure.

A natural gas fuel line 132 may be used to move the natural gas from the tanks 130 into the system 100 and more particularly into a pressure reducer 138. The natural gas fuel line 132 may comprise a natural gas pressure sensor 134 configured to sense the pressure of the natural gas and send data to the computer 110. The natural gas fuel line 132 may further comprise a fuel shut-off valve 136 configured to open and close thereby stopping the flow of natural gas into the pressure reducer 138.

The pressure reducer 138 may be configured to reduce the pressure of the natural gas fluid. The pressure reducer 138 may reduce the pressure of natural gas by providing volume of space for which the natural gas may freely expand thereby reducing its pressure. As heat is transferred or absorbed into the depressurizing fluid of natural gas, a heating element 139 may be employed to control the temperature of the pressure reducer 138. By controlling the temperature of the pressure reducer 138 freezing, condensation of water, and the formation of methane can be controlled. It may be noted that the natural gas may be inserted into the air flow system at a pressure in the range from about 10 psi to about 200 psi, or over a larger or smaller range.

A natural gas flow sensor 140 may be employed in the system 100 to sense the flow of natural gas in to the system 100. A natural gas flow controller 142 may be implemented to control the flow of natural gas in the system and may be controlled by the computer 110 or another control apparatus. The natural gas flow controller 142 may operate by opening and closing a valve that physically restricts the flow of the natural gas.

A natural gas injection assembly 144 may be employed in the system 100 and may comprise a natural gas nozzle 146 that is configured to inject natural gas into the air intake 106 such that the natural gas is mixed with the incoming air thereby creating a more energy rich combustible fluid. The nozzle 146 may be configured to disperse the natural gas in a homogeneous mixture and may produce a venturi effect in order to cause greater mixing of the incoming air and the natural gas.

The sensors as discussed above and the various control mechanisms may be electronically connected to a control unit 148. The control unit 148 may comprise components typical of control units such as a processor for processing data, memory for rapid data storage and data reading, storage for storing data, and circuitry supporting the components. The control unit 148 may also be configured with a visual display for visually displaying the data generated within the system 100. The control unit 148 may further comprise audio alerts. The control unit 148 may be configured to cause the system 100 to operate within a certain set of parameters by causing various control means to control their respective subjects. The control unit 148 may be fully engaged in the system 100 there by controlling all aspects of the operation of the system 100. In an embodiment the control unit 148 may be capable of partial control thereby leaving a portion of the system control to native control elements. The control unit may further comprise a communication device 150, such as a wireless transmitter that is configured to communicate with other systems or a control base thereby forming a network. Any data transmitted to the computer can be transmitted to the control unit 148.

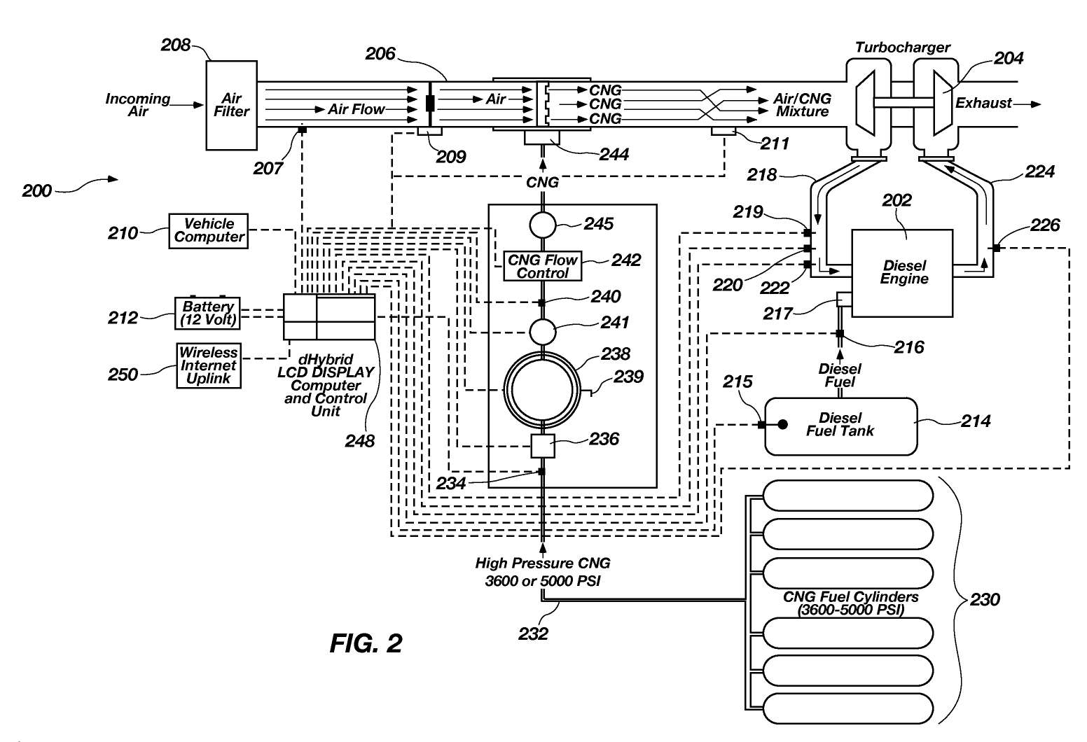

Referring now to FIG. 2, an embodiment of a system 200 for fueling an engine with a fuel comprising diesel and natural gas will be discussed. The system 200 may comprise an engine 202 as a primary component. The engine 202 may be of diesel configuration as is well known in the art and may further comprise a turbo charger 204 for suppling the engine 202 with improved combustibles. An air intake 206 may be incorporated to provide air into the system 200 and may have an air filter 208 attached thereto. The air intake 206 may also comprise an air temperature sensor 207 for sensing the temperature of the air going into the system thereby assisting the system in determine the density of the air. The air intake 206 may comprise a mass air flow sensor 209 for sensing the mass of the air flowing into the system 200. The air take intake 206 may comprise a mass air flow sensor 211 located between a natural gas injector assembly 244 and the turbo charger 204 to provide additional data to a computer 210. The system 200 may further comprise a computer 210 for processing data from said sensors. The system 200 may comprise a battery 212 for suppling electrical power to components of the system 200 that rely on electrical power in order to operate within the system 200. The system 200 may comprise a fuel tank 214 for holding fuel for powering the engine 202. The fuel tank 214 may comprise a fuel level sensor 215 for sensing the level of the fuel in the fuel tank 214 and may be configured for communicating fuel data to the computer 210. The system 200 may further comprise a diesel fuel flow sensor 216 that senses the flow volume of diesel fuel into the engine 202. Engine 202 may use an injection process to inject diesel fuel into the engine 202 by way of a diesel fuel injection pump 217.

The turbo charger 204 may interface with the engine 202 through an inlet channel 218 that has been configured to facilitate the movement of fluids (gas or liquid) into the engine 202. The inlet channel 218 may comprise a temperature sensor 219 for sensing the temperature of the air in the inlet channel and reporting the resultant data to the computer 210. The inlet channel 218 may comprise a pressure sensor 220 for sensing the pressure of the fluid mixture in the inlet channel 218. The inlet channel 218 may comprise a pressure switch 222 configured to control the pressure of the fluids in the inlet channel 218 so as to allow control of the fluids in the inlet channel 218 as it enters the engine 202.

After the engine 202 has consumed the chemical energy of the fuel air mixture entering the engine 202 by way of the inlet channel 218, exhaust gasses enter an outlet channel 224. The outlet channel 224 may comprise an exhaust temperature sensor 226. The outlet channel 224 channels the exhaust fluids into the turbo charger 204 to actuate the working elements of a turbo charger as is well known in the art.

The system 200 may further comprise natural gas fuel tanks 230. A single natural gas fuel tank may be used or a bank or array of fuel tanks may be used. The tanks 230 may be pressurized in a range from about 2500 psi to about 7000 psi. It will be appreciated that tanks containing pressures outside that range may also be used by the disclosure and it is within the scope of this disclosure to contemplate tanks pressurized to far higher pressures or far lower pressures than provided in the above range. The pressures of the tanks 230 within the system 200 are generally pressurized such that the pressure differential between the operating pressure of the system and the pressure in the tank or tanks causes natural gas to flow from the tanks 230 to the system 200. Accordingly any pressure or means for facilitating flow from tanks into an engine system is within the scope of this disclosure.

A natural gas fuel line 232 may be used to move the natural gas from the tanks 230 into the system 200 and more particularly into a pressure reducer 238. The natural gas fuel line 232 may comprise a natural gas pressure sensor 234 configured to sense the pressure of the natural gas and send data to the computer 210. The natural gas fuel line 232 may further comprise a fuel shut-off valve 236 configured to open and close thereby stopping the flow of natural gas into the pressure reducer 238.

The pressure reducer 238 may be configured to reduce the pressure of the natural gas fluid. The pressure reducer 238 may reduce the pressure of natural gas by providing volume of space for which the natural gas may freely expand thereby reducing its pressure. As heat is transferred or absorbed into the depressurizing fluid of natural gas, a heating element 239 may be employed to control the temperature of the pressure reducer 238. By controlling the temperature of the pressure reducer 238 freezing, condensation of water, and the formation of methane can be controlled. It may be noted that the natural gas may be inserted into the air flow system at a pressure in the range from about 10 psi to about 200 psi, or over a larger or smaller range.

A motorized control valve 241 may be employed to control the flow of natural gas after it has been depressurized. A natural gas flow sensor 240 may be used inline after the motorized control valve 241 in order to monitor the operation of the control valve 241. A diaphragm metering valve 243 may be incorporated to react to changes in the negative pressure created in the air intake 206 as a result of the turbo charger 204. The diaphragm metering valve 243 may be passive and made of a material with a predetermined bias or elasticity to properly control the flow of the natural gas in direct response to the changes in the system 200. For example, the material may be made from silicon or from multiple layers of silicon. In an embodiment, multiple diaphragms may be used in place of a single diaphragm. A natural gas injection assembly 244 may be included to disperse the natural gas into the air flow in the air intake 206.

The sensors as discussed above and the various control mechanisms may be electronically connected to a control unit 248. The control unit 248 may comprise components typical of control units such as a processor for processing data, memory for rapid data storage and data reading, storage for storing data, and circuitry supporting the components. The control unit 248 may also be configured with a visual display for visually displaying the data generated within the system 200. The control unit 248 may further comprise audio alerts. The control unit 248 may be configured to cause the system 200 to operate within a certain set of parameters by causing various control means to control their respective subjects. The control unit 248 may be fully engaged in the system 200 thereby controlling all aspects of the operation of the system 200. In an embodiment the control unit 248 may be capable of partial control thereby leaving a portion of the system control to native control elements. The control unit may further comprise a communication device 250, such as a wireless transmitter that is configured to communicate with other systems or a control base thereby forming a network. Any data transmitted to the computer can be transmitted to the control unit 248.

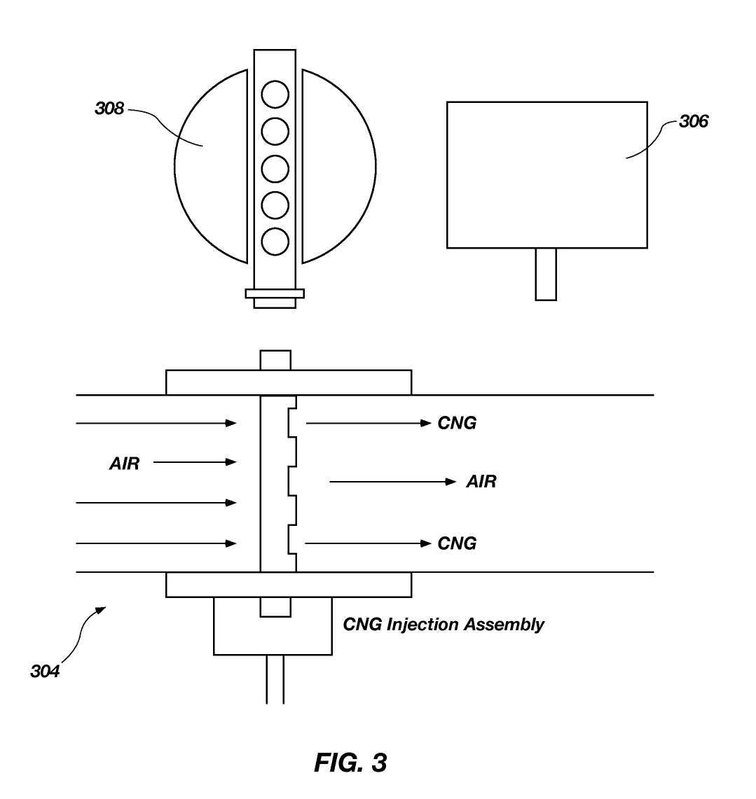

With reference to FIG. 3, the design of a natural gas injection assembly will be discussed in greater detail. 304 illustrates a portion on an air intake on an engine having a natural gas injection assembly interacting therewith. As can be seen in the illustration air is mixed with natural gas by the injection assembly. 308 represents a top down view of an injection means having open ports the may be adjusted relative to the direction of air flow in an air intake thereby dispersing the natural gas in a predetermined manner. 306 illustrates a side view of the natural gas injection assembly, showing the simplicity that the physical form may take. The ratio range at which natural gas and diesel can be mixed within the scope of the system may be from a ratio of 1:1 to 1:10. Other ratios are contemplated to be within the scope of this disclosure.

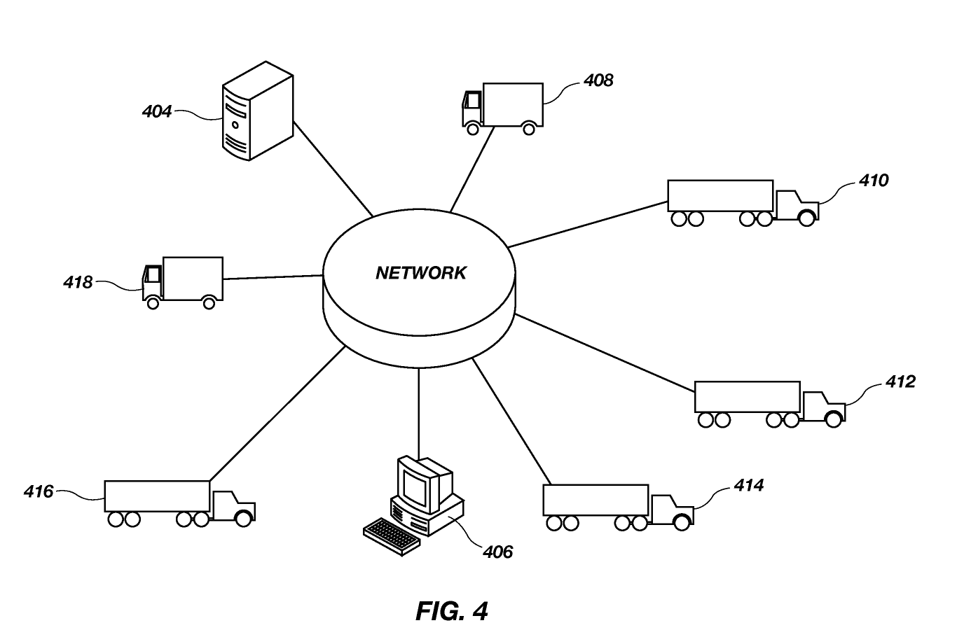

With reference to FIG. 4, a network employing the system 100 will be discussed wherein a plurality of trucks and a base unit are used to form the network. In order to maximize the efficiency of the system, a database can be developed and maintained on a server 404. The server 404 comprises the components typical of computer server. In particular the server 404 comprises a storage whereon the data collected from other network members can be stored for later access. The network members may comprise trucks, trains, ships and other means of transport and travel. A truck 408 has been fitted with system 100 and is therefor capable of operating on a mixture of natural gas and diesel. The system 100 monitors the operating characteristics of truck 408 such as location, route, fuel consumption, load, incline of road, speed and acceleration. Many other characteristics may be monitored and reported by a truck to the server for analysis and storage. With each member of the network reporting the operating conditions, a database can be developed that can be used to guide the members of the network on the most efficient use of system 100. For example, truck 410 may be followed on the same route with similar loads by trucks 412 and 414. The system 100 on truck 410 may report over the network the operating conditions it is experiencing. Trucks 412 and 414 may receive the data from truck 410 over the network and can make adjustments on the fly as to the way they operate over the same portion of the route. Truck 412 may provide a further refinement of the operational data from which latter truck 414 may further benefit. Truck 416 may make the trip later in time and may receive refined data stored on the server 404 for trucks 410, 412, and 414. A terminal 406 may allow access to the network for users such that they can monitor the operational data from the truck members of the network and input data onto the network that will be received by the truck members. A user at a terminal 406 may further use the network to compare two trucks in route such as trucks 408 and 418. Control parameters may be transmitted over the network, such that members may be parameters from which to operate for a period of time.

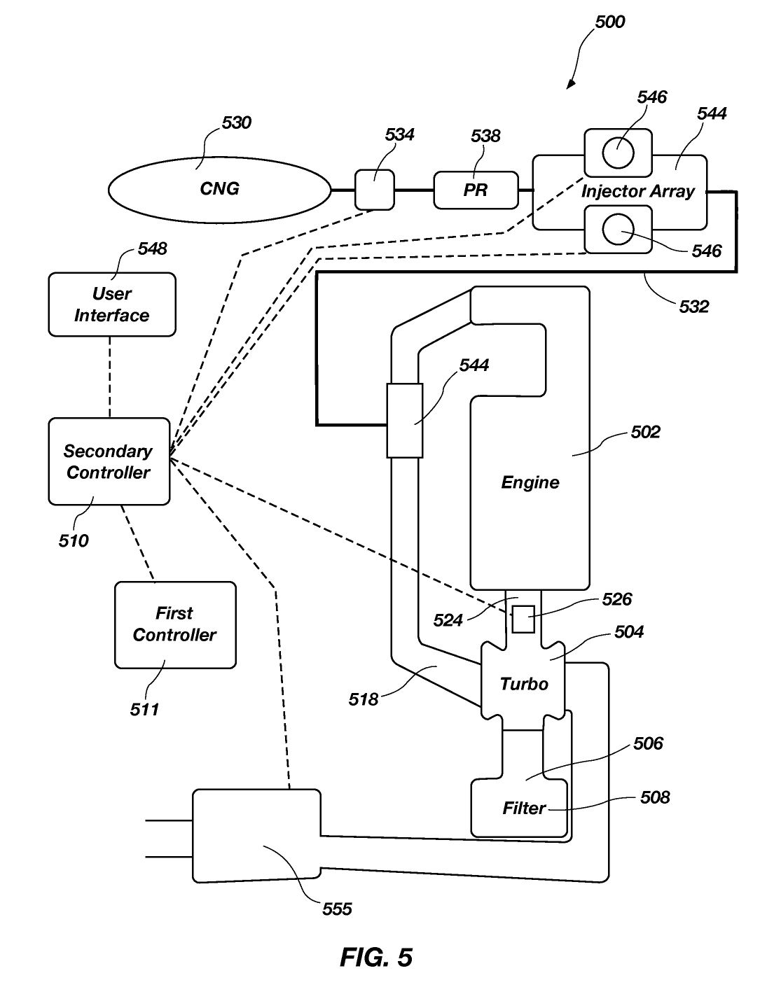

With reference primarily to FIG. 5, a system 500 for fueling an engine with a fuel comprising diesel and natural gas will be discussed. The system 500 may comprise an engine 502 as a primary component. The engine 502 may be of diesel configuration as is well known in the art and may further comprise a turbo charger 504 for suppling the engine 502 with improved combustibles. An air intake 506 may be incorporated to provide air into the system 500 and may have an air filter 508 attached thereto. The air intake 506 may also comprise an air temperature sensor for sensing the temperature of the air going into the system thereby assisting the system in determine the density of the air. The air intake 506 may comprise a mass air flow sensor for sensing the mass of the air flowing into the system 500. The air take intake 506 may comprise a mass air flow sensor located between a natural gas injector assembly 544 and the turbo charger 504 to provide additional data to a computer 510. The system 500 may further comprise the computer 510 for processing data from said sensors. The computer 510 may be a secondary or second computer the may or may not be electronically connected to a primary or first computer 511 leaving the primary or first computer 511 to responsively function to the introduction of natural gas. The secondary or second computer 510 and the primary or first computer 511 may be linked or connected electronically so as to communicate with one another for greater flexibility in the system 500. The secondary or second computer 510 may have a one way communication with the primary or first computer 511, so as to receive information and data from the primary or first computer 511, but not transmit data to the primary or first computer 511. Such data may include engine load, engine speed, fuel input, various mass flows from throughout the system 500, and various temperatures at locations throughout the system 500. The system 500 may comprise a battery for suppling electrical power to components of the system 500 that rely on electrical power in order to operate within the system 500. The system 500 may comprise a fuel tank for holding fuel for powering the engine 502. The fuel tank may comprise a fuel level sensor for sensing the level of the fuel in the fuel tank and may be configured for communicating fuel data to the computers 510 and/or 511. The system 500 may further comprise a diesel fuel flow sensor that senses the flow volume of diesel fuel into the engine. Engine 502 may use an injection process to inject diesel fuel into the engine 502 by way of a diesel fuel injection pump.

The turbo charger 504 may interface with the engine 502 through an inlet channel 518 that has been configured to facilitate the movement of fluids (gas or liquid) into the engine 502. The inlet channel 518 may comprise a temperature sensor for sensing the temperature of the air in the inlet channel and reporting the resultant data to the computer 510. The inlet channel 518 may comprise a pressure sensor for sensing the pressure of the fluid mixture in the inlet channel 518. The inlet channel 518 may comprise a pressure switch configured to control the pressure of the fluids in the inlet channel 518 so as to allow control of the fluids in the inlet channel 518 as it enters the engine 502.

After the engine 502 has consumed the chemical energy of the fuel air mixture entering the engine 502 by way of the inlet channel 518, exhaust gasses enter an outlet channel 524. The outlet channel 524 may comprise an exhaust temperature sensor 526. The outlet channel 524 channels the exhaust fluids into the turbo charger 504 to actuate the working elements of a turbo charger as is well known in the art.

The system 500 may further comprise natural gas fuel tanks 530. A single natural gas fuel tank may be used or a bank or array of fuel tanks may be used. The tanks 530 may be pressurized in a range from about 2500 psi to about 7000 psi. It will be appreciated that tanks containing pressures outside that range may also be used by the disclosure and it is within the scope of this disclosure to contemplate tanks pressurized to far higher pressures or far lower pressures than provided in the above range. The pressures of the tanks 530 within the system 500 are generally pressurized such that the pressure differential between the operating pressure of the system and the pressure in the tank or tanks causes natural gas to flow from the tanks 530 to the system 500. Accordingly any pressure or means for facilitating flow from tanks into an engine system is within the scope of this disclosure.

A natural gas fuel line 532 may be used to move the natural gas from the tanks 530 into the system 500 and more particularly into a pressure reducer 538. The natural gas fuel line 532 may comprise a natural gas pressure sensor 534 configured to sense the pressure of the natural gas and send data to the computer 510. The natural gas fuel line 532 may further comprise a fuel shut-off valve configured to open and close thereby stopping the flow of natural gas into the pressure reducer 538.

The pressure reducer 538 may be configured to reduce the pressure of the natural gas fluid. The pressure reducer 538 may reduce the pressure of natural gas by providing volume of space for which the natural gas may freely expand thereby reducing its pressure. As heat is transferred or absorbed into the depressurizing fluid of natural gas, a heating element may be employed to control the temperature of the pressure reducer 538. By controlling the temperature of the pressure reducer 538 freezing, condensation of water, and the formation of methane can be controlled. It may be noted that the natural gas may be inserted into the air flow system at a pressure in the range from about 10 psi to about 200 psi, or over a larger or smaller range. Heat may be applied to other elements of the system 500 to control freezing and other operating conditions of the components. For example, the tanks and the natural gas lines within the system 500 may benefit from thermal control.

A natural gas flow sensor may be employed in the system 500 to sense the flow of natural gas in to the system 500. A natural gas flow controller may be implemented to control the flow of natural gas in the system and may be controlled by the computer 510 or another control apparatus. The natural gas flow controller may operate by opening and closing a valve that physically restricts the flow of the natural gas.

A natural gas injection assembly or array 544 maybe employed in the system 500 and may comprise a natural gas injector 546 or a plurality of natural gas injectors, that are configured to inject natural gas into the air intake 506 such that the natural gas is mixed with the incoming air thereby creating a more energy rich combustible fluid. The injector 546 may be configured to disperse the natural gas in a homogeneous mixture and may produce a venturi effect in order to cause greater mixing of the incoming air and the natural gas. The array 544 of injectors 546 may cause the injectors 546 to operate independently from one another or in concert, as discussed in greater detail below. The introduction of natural gas may be made prior to the turbo charger 504 or after the turbo charger 504.

The sensors as discussed above and the various control mechanisms may be electronically connected to a control unit 548. The control unit 548 may comprise components typical of control units such as a processor for processing data, memory for rapid data storage and data reading, storage for storing data, and circuitry supporting the components. The control unit 548 may also be configured with a visual display for visually displaying the data generated within the system 500 and may communicate with the computers 510 and 511. The control unit 548 may further comprise audio alerts. The control unit 548 may be configured to cause the system 500 to operate within a certain set of parameters by causing various control means to control their respective subjects. The control unit 548 may be fully engaged in the system 500 there by controlling all aspects of the operation of the system 500. In an embodiment the control unit 548 may be capable of partial control thereby leaving a portion of the system control to native control elements. The control unit may further comprise a communication device, such as a wireless transmitter that is configured to communicate with other systems or a control base thereby forming a network. Any data transmitted to the computer can be transmitted to the control unit 548. The system 500 may further include exhaust sensors 555 in order to comply with regulatory systems and requirements.

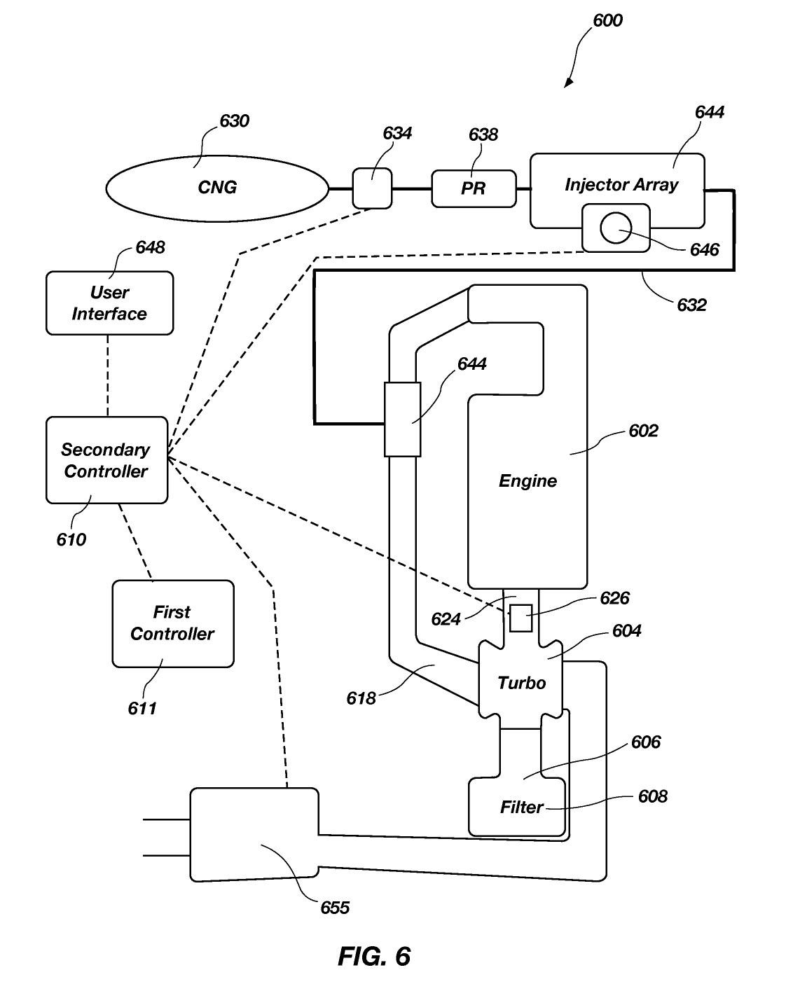

With reference primarily to FIG. 6, a system 600 for fueling an engine with a fuel comprising diesel and natural gas will be discussed having a single natural gas injector. The system 600 may comprise an engine 602 as a primary component. The engine 602 may be of diesel configuration as is well known in the art and may further comprise a turbo charger 604 for suppling the engine 602 with improved combustibles. An air intake 606 may be incorporated to provide air into the system 600 and may have an air filter 608 attached thereto. The air intake 606 may also comprise an air temperature sensor for sensing the temperature of the air going into the system thereby assisting the system in determine the density of the air. The air intake 606 may comprise a mass air flow sensor for sensing the mass of the air flowing into the system 600. The air take intake 606 may comprise a mass air flow sensor located between a natural gas injector assembly 644 and the turbo charger 604 to provide additional data to a computer 610. The system 600 may further comprise the computer 610 for processing data from said sensors. The computer 610 may be a secondary computer the may or may not be electronically connected to a primary or first computer 611 leaving the primary or first computer 611 to responsively function to the introduction of natural gas. The secondary or second computer 610 and the primary or first computer 611 may be linked or connected electronically so as to communicate with one another for greater flexibility in the system 600. The secondary or second computer 610 may have a one way communication with the primary or first computer 611, so as to receive information and data from the primary or first computer 611 but not transmit data to the primary or first computer 611. Such data may include engine load, engine speed, fuel input, various mass flows from throughout the system 600, and various temperatures at locations throughout the system 600. The system 600 may comprise a battery for suppling electrical power to components of the system 600 that rely on electrical power in order to operate within the system 600. The system 600 may comprise a fuel tank for holding fuel for powering the engine 602. The fuel tank may comprise a fuel level sensor for sensing the level of the fuel in the fuel tank and may be configured for communicating fuel data to the computers 610 and/or 611. The system 600 may further comprise a diesel fuel flow sensor that senses the flow volume of diesel fuel into the engine. Engine 602 may use an injection process to inject diesel fuel into the engine 602 by way of a diesel fuel injection pump.

The turbo charger 604 may interface with the engine 602 through an inlet channel 618 that has been configured to facilitate the movement of fluids (gas or liquid) into the engine 602. The inlet channel 618 may comprise a temperature sensor for sensing the temperature of the air in the inlet channel and reporting the resultant data to the computer 610. The inlet channel 618 may comprise a pressure sensor for sensing the pressure of the fluid mixture in the inlet channel 618. The inlet channel 618 may comprise a pressure switch configured to control the pressure of the fluids in the inlet channel 618 so as to allow control of the fluids in the inlet channel 618 as it enters the engine 602.

After the engine 602 has consumed the chemical energy of the fuel air mixture entering the engine 602 by way of the inlet channel 618, exhaust gasses enter an outlet channel 624. The outlet channel 624 may comprise an exhaust temperature sensor 626. The outlet channel 624 channels the exhaust fluids into the turbo charger 604 to actuate the working elements of a turbo charger as is well known in the art.

The system 600 may further comprise natural gas fuel tanks 630. A single natural gas fuel tank may be used or a bank or array of fuel tanks may be used. The tanks 630 may be pressurized in a range from about 2500 psi to about 7000 psi. It will be appreciated that tanks containing pressures outside that range may also be used by the disclosure and it is within the scope of this disclosure to contemplate tanks pressurized to far higher pressures or far lower pressures than provided in the above range. The pressures of the tanks 630 within the system 600 are generally pressurized such that the pressure differential between the operating pressure of the system and the pressure in the tank or tanks causes natural gas to flow from the tanks 630 to the system 600. Accordingly any pressure or means for facilitating flow from tanks into an engine system is within the scope of this disclosure.

A natural gas fuel line 632 may be used to move the natural gas from the tanks 630 into the system 600 and more particularly into a pressure reducer 638. The natural gas fuel line 632 may comprise a natural gas pressure sensor 634 configured to sense the pressure of the natural gas and send data to the computer 610. The natural gas fuel line 632 may further comprise a fuel shut-off valve configured to open and close thereby stopping the flow of natural gas into the pressure reducer 638.

The pressure reducer 638 may be configured to reduce the pressure of the natural gas fluid. The pressure reducer 638 may reduce the pressure of natural gas by providing volume of space for which the natural gas may freely expand thereby reducing its pressure. As heat is transferred or absorbed into the depressurizing fluid of natural gas, a heating element may be employed to control the temperature of the pressure reducer 638. By controlling the temperature of the pressure reducer 638 freezing, condensation of water, and the formation of methane can be controlled. It may be noted that the natural gas may be inserted into the air flow system at a pressure in the range from about 10 psi to about 200 psi, or over a larger or smaller range. Heat may be applied to other elements of the system 600 to control freezing and other operating conditions of the components. For example the tanks and the natural gas lines within the system 600 may benefit from thermal control.

A natural gas flow sensor may be employed in the system 600 to sense the flow of natural gas in to the system 600. A natural gas flow controller may be implemented to control the flow of natural gas in the system and may be controlled by the computer 610 or another control apparatus. The natural gas flow controller may operate by opening and closing a valve that physically restricts the flow of the natural gas.

As seen in the FIG. 6 a single natural gas injector is used in an embodiment. A natural gas injection assembly or array 644 may be employed in the system 600 and may comprise a natural gas injector 646 or a plurality of natural gas injectors, that are configured to inject natural gas into the air intake 606 such that the natural gas is mixed with the incoming air thereby creating a more energy rich combustible fluid. The injector 646 may be configured to disperse the natural gas in a homogeneous mixture and may produce a venturi effect in order to cause greater mixing of the incoming air and the natural gas. The array 644 of injectors 646 may cause the injectors 646 to operate independently from one another or in concert, as discussed in greater detail below. The introduction of natural gas may be made prior to the turbo charger 604 or after the turbo charger 604.

The sensors as discussed above and the various control mechanisms may be electronically connected to a control unit 648. The control unit 648 may comprise components typical of control units such as a processor for processing data, memory for rapid data storage and data reading, storage for storing data, and circuitry supporting the components. The control unit 648 may also be configured with a visual display for visually displaying the data generated within the system 600 and may communicate with the computers 610 and 611. The control unit 648 may further comprise audio alerts. The control unit 648 may be configured to cause the system 600 to operate within a certain set of parameters by causing various control means to control their respective subjects. The control unit 648 may be fully engaged in the system 600 there by controlling all aspects of the operation of the system 600. In an embodiment the control unit 648 may be capable of partial control thereby leaving a portion of the system control to native control elements. The control unit may further comprise a communication device, such as a wireless transmitter that is configured to communicate with other systems or a control base thereby forming a network. Any data transmitted to the computer can be transmitted to the control unit 648. The system 600 may further include exhaust sensors 655 in order to comply with regulatory systems and requirements.

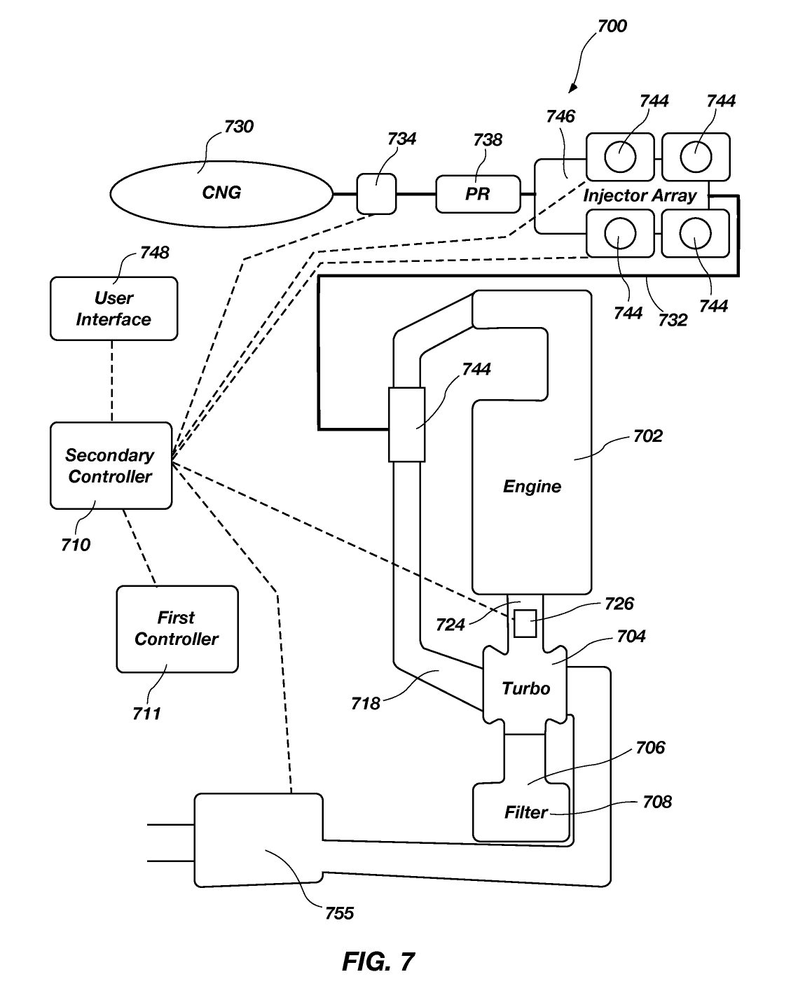

With reference primarily to FIG. 7, a system 700 for fueling an engine with a fuel comprising diesel and natural gas will be discussed having a plurality of natural gas injectors. The system 700 may comprise an engine 702 as a primary component. The engine 702 may be of diesel configuration as is well known in the art and may further comprise a turbo charger 704 for suppling the engine 702 with improved combustibles. An air intake 706 may be incorporated to provide air into the system 700 and may have an air filter 708 attached thereto. The air intake 706 may also comprise an air temperature sensor for sensing the temperature of the air going into the system thereby assisting the system in determine the density of the air. The air intake 706 may comprise a mass air flow sensor for sensing the mass of the air flowing into the system 700. The air take intake 706 may comprise a mass air flow sensor located between a natural gas injector assembly 744 and the turbo charger 704 to provide additional data to a computer 710. The system 700 may further comprise the computer 710 for processing data from said sensors. The computer 710 may be a secondary computer the may or may not be electronically connected to a primary or first computer 711 leaving the primary or first computer 711 to responsively function to the introduction of natural gas. The secondary computer 710 and the primary or first computer 711 may be linked or connected electronically so as to communicate with one another for greater flexibility in the system 700. The secondary computer 710 may have a one way communication with the primary or first computer 711, so as to receive information and data from the primary or first computer 711 but not transmit data to the primary or first computer 711. Such data may include engine load, engine speed, fuel input, various mass flows from throughout the system 700, and various temperatures at locations throughout the system 700. The system 700 may comprise a battery for suppling electrical power to components of the system 700 that rely on electrical power in order to operate within the system 700. The system 700 may comprise a fuel tank for holding fuel for powering the engine 702. The fuel tank may comprise a fuel level sensor for sensing the level of the fuel in the fuel tank and may be configured for communicating fuel data to the computers 710 and/or 711. The system 700 may further comprise a diesel fuel flow sensor that senses the flow volume of diesel fuel into the engine. Engine 702 may use an injection process to inject diesel fuel into the engine 702 by way of a diesel fuel injection pump. The first or primary controller may aid in a map table or a plurality of map tables. The second or secondary controller may retrieve and execute instructions derived from the map tables.

The turbo charger 704 may interface with the engine 702 through an inlet channel 718 that has been configured to facilitate the movement of fluids (gas or liquid) into the engine 702. The inlet channel 718 may comprise a temperature sensor for sensing the temperature of the air in the inlet channel and reporting the resultant data to the computer 710. The inlet channel 718 may comprise a pressure sensor for sensing the pressure of the fluid mixture in the inlet channel 718. The inlet channel 718 may comprise a pressure switch configured to control the pressure of the fluids in the inlet channel 718 so as to allow control of the fluids in the inlet channel 718 as it enters the engine 702.

After the engine 702 has consumed the chemical energy of the fuel air mixture entering the engine 702 by way of the inlet channel 718, exhaust gasses enter an outlet channel 724. The outlet channel 724 may comprise an exhaust temperature sensor 726. The outlet channel 724 channels the exhaust fluids into the turbo charger 704 to actuate the working elements of a turbo charger as is well known in the art.

The system 700 may further comprise natural gas fuel tanks 730. A single natural gas fuel tank may be used or a bank or array of fuel tanks may be used. The tanks 730 may be pressurized in a range from about 2500 psi to about 7000 psi. It will be appreciated that tanks containing pressures outside that range may also be used by the disclosure and it is within the scope of this disclosure to contemplate tanks pressurized to far higher pressures or far lower pressures than provided in the above range. The pressures of the tanks 730 within the system 700 are generally pressurized such that the pressure differential between the operating pressure of the system and the pressure in the tank or tanks causes natural gas to flow from the tanks 730 to the system 700. Accordingly any pressure or means for facilitating flow from tanks into an engine system is within the scope of this disclosure.

A natural gas fuel line 732 may be used to move the natural gas from the tanks 730 into the system 700 and more particularly into a pressure reducer 738. The natural gas fuel line 732 may comprise a natural gas pressure sensor 734 configured to sense the pressure of the natural gas and send data to the computer 710. The natural gas fuel line 732 may further comprise a fuel shut-off valve configured to open and close thereby stopping the flow of natural gas into the pressure reducer 738.

The pressure reducer 738 may be configured to reduce the pressure of the natural gas fluid. The pressure reducer 738 may reduce the pressure of natural gas by providing volume of space for which the natural gas may freely expand thereby reducing its pressure. As heat is transferred or absorbed into the depressurizing fluid of natural gas, a heating element may be employed to control the temperature of the pressure reducer 738. By controlling the temperature of the pressure reducer 738 freezing, condensation of water, and the formation of methane can be controlled. It may be noted that the natural gas may be inserted into the air flow system at a pressure in the range from about 10 psi to about 200 psi, or over a larger or smaller range. Heat may be applied to other elements of the system 700 to control freezing and other operating conditions of the components. For example the tanks and the natural gas lines within the system 700 may benefit from thermal control.

A natural gas flow sensor may be employed in the system 700 to sense the flow of natural gas in to the system 700. A natural gas flow controller may be implemented to control the flow of natural gas in the system and may be controlled by the computer 710 or another control apparatus. The natural gas flow controller may operate by opening and closing a valve that physically restricts the flow of the natural gas.

A natural gas injection assembly or array 744 maybe employed in the system 700 and may comprise a natural gas injector 746 or a plurality of natural gas injectors, that are configured to inject natural gas into the air intake 706 such that the natural gas is mixed with the incoming air thereby creating a more energy rich combustible fluid. The injector 746 may be configured to disperse the natural gas in a homogeneous mixture and may produce a venturi effect in order to cause greater mixing of the incoming air and the natural gas. Shown in the corresponding figure is an array of four injectors. It is within the scope of the disclosure to anticipate any number of injectors and apply those injectors in concert. The array of injectors may be independently controlled so as to overlap one another in duration or may have multiple injectors open and close simultaneously. The array 744 of injectors 746 may cause the injectors 746 to operate independently from one another or in concert, as discussed in greater detail below. The introduction of natural gas may be made prior to the turbo charger 704 or after the turbo charger 704.

The sensors as discussed above and the various control mechanisms may be electronically connected to a control unit 748. The control unit 748 may comprise components typical of control units such as a processor for processing data, memory for rapid data storage and data reading, storage for storing data, and circuitry supporting the components. The control unit 748 may also be configured with a visual display for visually displaying the data generated within the system 700 and may communicate with the computers 710 and 711. The control unit 748 may further comprise audio alerts. The control unit 748 may be configured to cause the system 700 to operate within a certain set of parameters by causing various control means to control their respective subjects. The control unit 748 may be fully engaged in the system 700 there by controlling all aspects of the operation of the system 700. In an embodiment the control unit 748 may be capable of partial control thereby leaving a portion of the system control to native control elements. The control unit may further comprise a communication device, such as a wireless transmitter that is configured to communicate with other systems or a control base thereby forming a network. Any data transmitted to the computer can be transmitted to the control unit 748. The system 700 may further include exhaust sensors 755 in order to comply with regulatory systems and requirements.

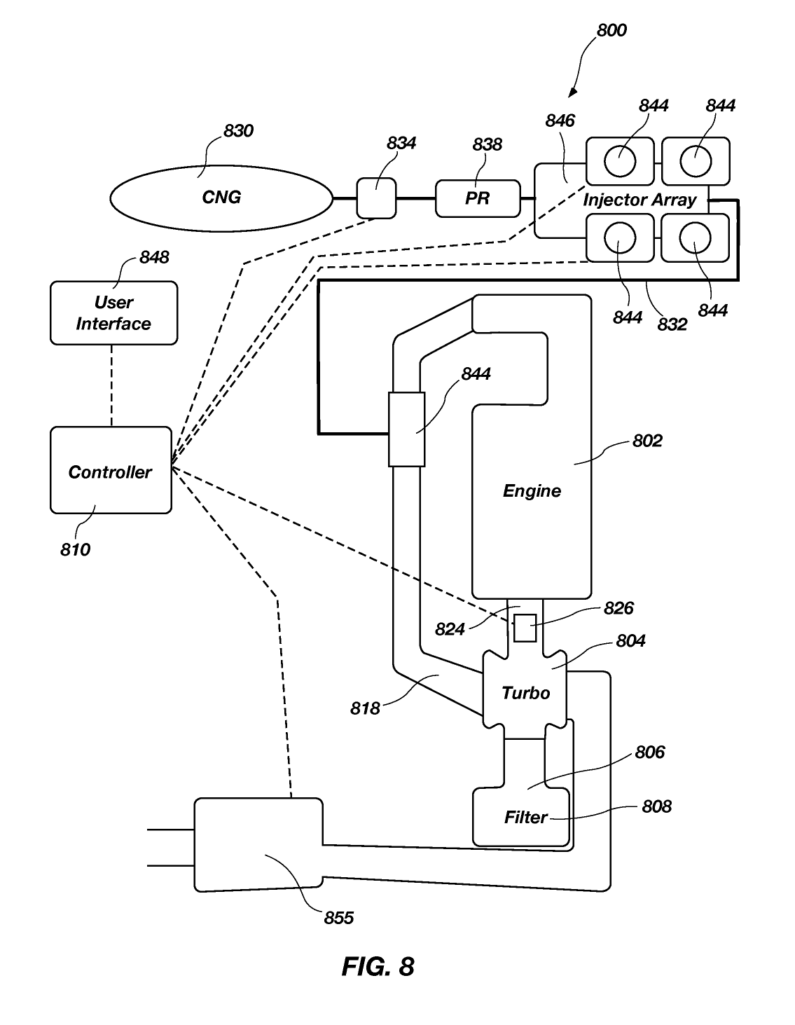

With reference primarily to FIG. 8, a system 800 for fueling an engine with a fuel comprising diesel and natural gas will be discussed having a having a single controller or a first controller. The system 800 may comprise an engine 802 as a primary component. The engine 802 may be of diesel configuration as is well known in the art and may further comprise a turbo charger 804 for suppling the engine 802 with improved combustibles. An air intake 806 may be incorporated to provide air into the system 800 and may have an air filter 808 attached thereto. The air intake 806 may also comprise an air temperature sensor for sensing the temperature of the air going into the system thereby assisting the system in determine the density of the air. The air intake 806 may comprise a mass air flow sensor for sensing the mass of the air flowing into the system 800. The air take intake 806 may comprise a mass air flow sensor located between a natural gas injector assembly 844 and the turbo charger 804 to provide additional data to a computer 810. The system 800 may further comprise the single computer or controller 810 for processing data from said sensors. The system 800 may comprise a battery for suppling electrical power to components of the system 800 that rely on electrical power in order to operate within the system 800. The system 800 may comprise a fuel tank for holding fuel for powering the engine 802. The fuel tank may comprise a fuel level sensor for sensing the level of the fuel in the fuel tank and may be configured for communicating fuel data to the computer 810. The system 800 may further comprise a diesel fuel flow sensor that senses the flow volume of diesel fuel into the engine. Engine 802 may use an injection process to inject diesel fuel into the engine 802 by way of a diesel fuel injection pump.

The turbo charger 804 may interface with the engine 802 through an inlet channel 818 that has been configured to facilitate the movement of fluids (gas or liquid) into the engine 802. The inlet channel 818 may comprise a temperature sensor for sensing the temperature of the air in the inlet channel and reporting the resultant data to the computer 810. The inlet channel 818 may comprise a pressure sensor for sensing the pressure of the fluid mixture in the inlet channel 818. The inlet channel 818 may comprise a pressure switch configured to control the pressure of the fluids in the inlet channel 818 so as to allow control of the fluids in the inlet channel 818 as it enters the engine 802.

After the engine 802 has consumed the chemical energy of the fuel air mixture entering the engine 802 by way of the inlet channel 818, exhaust gasses enter an outlet channel 824. The outlet channel 824 may comprise an exhaust temperature sensor 826. The outlet channel 824 channels the exhaust fluids into the turbo charger 804 to actuate the working elements of a turbo charger as is well known in the art.

The system 800 may further comprise natural gas fuel tanks 830. A single natural gas fuel tank may be used or a bank or array of fuel tanks may be used. The tanks 830 may be pressurized in a range from about 2500 psi to about 8000 psi. It will be appreciated that tanks containing pressures outside that range may also be used by the disclosure and it is within the scope of this disclosure to contemplate tanks pressurized to far higher pressures or far lower pressures than provided in the above range. The pressures of the tanks 830 within the system 800 are generally pressurized such that the pressure differential between the operating pressure of the system and the pressure in the tank or tanks causes natural gas to flow from the tanks 830 to the system 800. Accordingly any pressure or means for facilitating flow from tanks into an engine system is within the scope of this disclosure.

A natural gas fuel line 832 may be used to move the natural gas from the tanks 830 into the system 800 and more particularly into a pressure reducer 838. The natural gas fuel line 832 may comprise a natural gas pressure sensor 834 configured to sense the pressure of the natural gas and send data to the computer 810. The natural gas fuel line 832 may further comprise a fuel shut-off valve configured to open and close thereby stopping the flow of natural gas into the pressure reducer 838.

The pressure reducer 838 may be configured to reduce the pressure of the natural gas fluid. The pressure reducer 838 may reduce the pressure of natural gas by providing volume of space for which the natural gas may freely expand thereby reducing its pressure. As heat is transferred or absorbed into the depressurizing fluid of natural gas, a heating element may be employed to control the temperature of the pressure reducer 838. By controlling the temperature of the pressure reducer 838 freezing, condensation of water, and the formation of methane can be controlled. It may be noted that the natural gas may be inserted into the air flow system at a pressure in the range from about 10 psi to about 200 psi, or over a larger or smaller range. Heat may be applied to other elements of the system 800 to control freezing and other operating conditions of the components. For example the tanks and the natural gas lines within the system 800 may benefit from thermal control.

A natural gas flow sensor may be employed in the system 800 to sense the flow of natural gas in to the system 800. A natural gas flow controller may be implemented to control the flow of natural gas in the system and may be controlled by the computer 810 or another control apparatus. The natural gas flow controller may operate by opening and closing a valve that physically restricts the flow of the natural gas.

A natural gas injection assembly or array 844 maybe employed in the system 800 and may comprise a natural gas injector 846 or a plurality of natural gas injectors, that are configured to inject natural gas into the air intake 806 such that the natural gas is mixed with the incoming air thereby creating a more energy rich combustible fluid. The injector 846 may be configured to disperse the natural gas in a homogeneous mixture and may produce a venturi effect in order to cause greater mixing of the incoming air and the natural gas. Shown in the corresponding figure is an array of four injectors. It is within the scope of the disclosure to anticipate any number of injectors and apply those injectors in concert. The array of injectors may be independently controlled so as to overlap one another in duration or may have multiple injectors open and close simultaneously. The array 844 of injectors 846 may cause the injectors 846 to operate independently from one another or in concert, as discussed in greater detail below. The introduction of natural gas may be made prior to the turbo charger 804 or after the turbo charger 804. Instructions may be derived or executed from map tables representing different operating states or conditions of use. One map table may represent data for use during a no load or light load operating state or condition. Another map table may represent data for heavy or high load operating state or condition, such as a truck that is pulling a full pay load.

The sensors as discussed above and the various control mechanisms may be electronically connected to a control unit 848. The control unit 848 may comprise components typical of control units such as a processor for processing data, memory for rapid data storage and data reading, storage for storing data, and circuitry supporting the components. The control unit 848 may also be configured with a visual display for visually displaying the data generated within the system 800 and may communicate with the computer 810. The control unit 848 may further comprise audio alerts. The control unit 848 may be configured to cause the system 800 to operate within a certain set of parameters by causing various control means to control their respective subjects. The control unit 848 may be fully engaged in the system 800 there by controlling all aspects of the operation of the system 800. In an embodiment the control unit 848 may be capable of partial control thereby leaving a portion of the system control to native control elements. The control unit may further comprise a communication device, such as a wireless transmitter that is configured to communicate with other systems or a control base thereby forming a network. Any data transmitted to the computer can be transmitted to the control unit 848. The system 800 may further include exhaust sensors 855 in order to comply with regulatory systems and requirements.

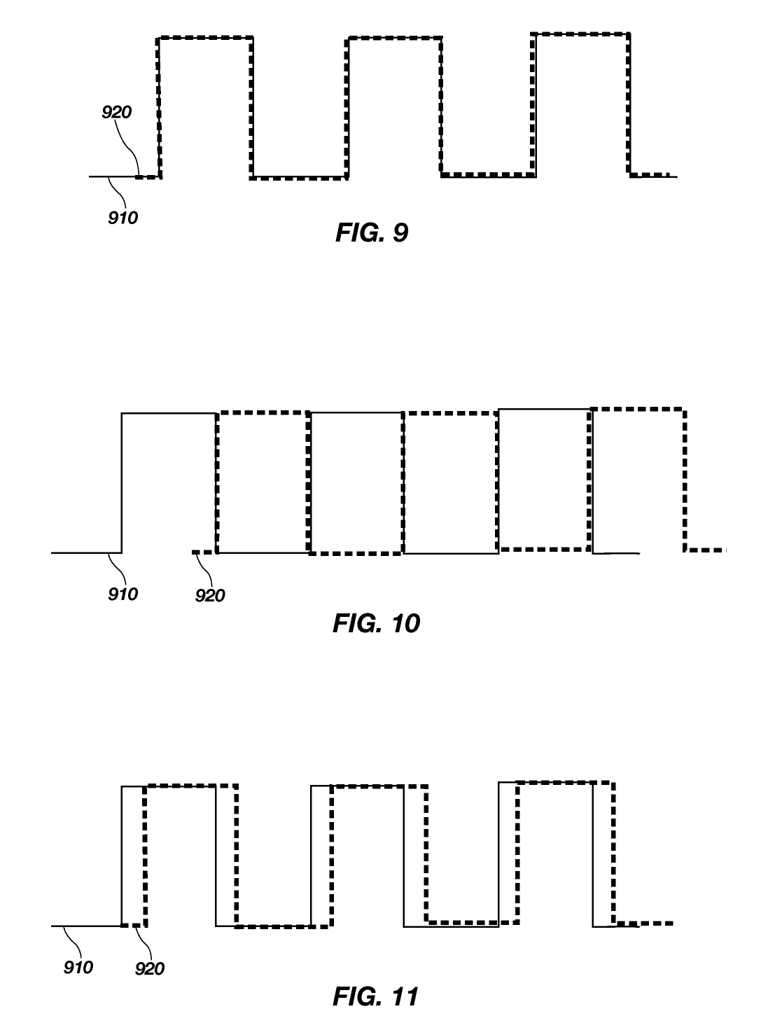

FIG. 9 illustrates a graphical representation of the operation of two natural gas injectors operating simultaneously as instructed by a map table. In the figure it can be seen that a solid line 910 may represent a first natural gas injector. In the figure it can be seen that a second dashed line 920 may represent a second natural gas injector. The figure illustrates a condition wherein the map table provides instructions causing the injectors to fire simultaneously. In contrast FIG. 10 illustrates a graphical representation wherein the injectors are instructed to fire at different times. In other words, where the first injector is open, the second is closed. This condition would also be derived from map tables. FIG. 11 illustrates a condition wherein the injectors are instructed to fire with an over lap. In other words before a first injector closes a second injector is opened. The advantage of over lapping operation of the injectors maybe to provide a more homogeneous mixtures of natural gas into a system.

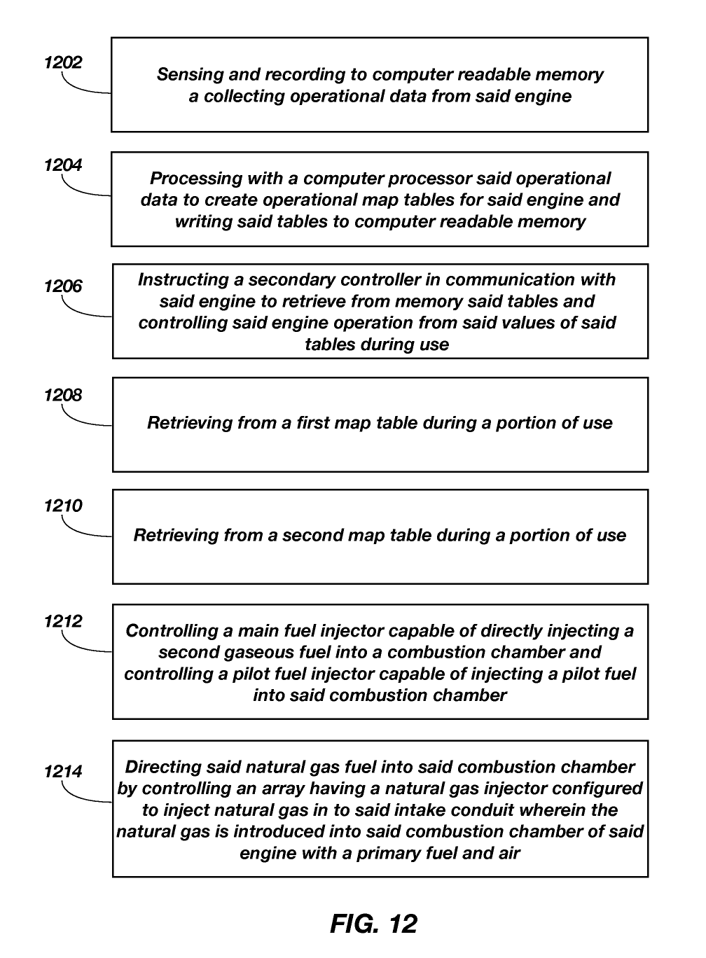

FIG. 12 illustrates a method of use for an apparatus that injects natural gas as an additional fuel. During use at 1202 the apparatus senses and records to computer readable memory a collection operational data from said engine. At 1204 a computer processor processes said operational data to create operational map tables for said engine and writing said tables to computer readable memory. At 1206 the apparatus is instructing a secondary controller in communication with said engine to retrieve from memory said tables and controlling said engine operation from said values of said tables during use. At 1208 the apparatus is retrieving from a first map table during a portion of use. At 1210 the apparatus is retrieving from a second map table during a portion of use. At 1212 the apparatus is Controlling a main fuel injector capable of directly injecting a second gaseous fuel into a combustion chamber and controlling a pilot fuel injector capable of injecting a pilot fuel into said combustion chamber. At 1214 the apparatus is directing said natural gas fuel into said combustion chamber by controlling an array having a natural gas injector configured to inject natural gas in to said intake conduit wherein the natural gas is introduced into said combustion chamber of said engine with a primary fuel and air.

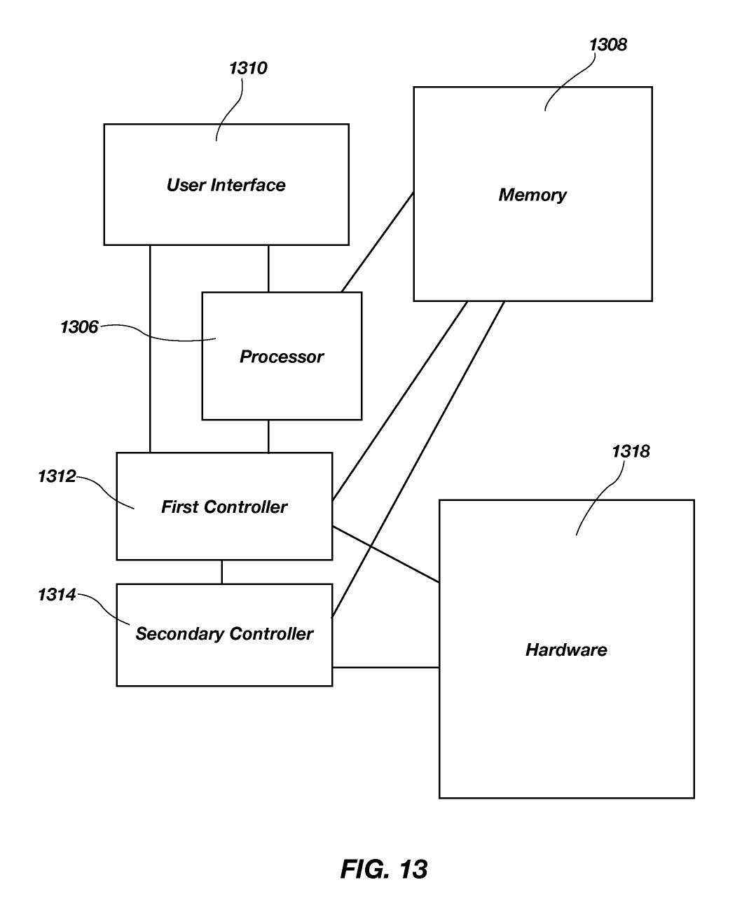

FIG. 13 illustrates an embodiment of an apparatus for controlling the injection of natural gas in schematic form illustrating the various components. An apparatus may have a processor 1306 for processing data within the system. A processor 1306 may be included in a primary or first controller 1312 and a secondary controller 1314. An apparatus may have a user interface for displaying operational information of the system to a user, and may be used for receiving instruction from a user as discussed above. The apparatus may include memory 1308 or storage for storing map tables and data thereon. The memory 1308 may be accessed by the processor 1306, the first controller 1312, and/or the secondary controller 1314. The above components may be used in concert to control the hardware 1318 of the apparatus as discussed above. The components of the apparatus may be connected electronically and may be part of a network as is commonly known in the art.

It is within the scope of the disclosure to offer the components of the system in a kit form that can be fitted to a variety of vehicles.

An embodiment may comprise a plurality of sensors for collecting operational data from the engine, wherein said operational data comprises engine speed, engine load, and mass flow into said engine, and a first controller that processes said operational data to create operational map tables for said engine. The embodiment may further comprise a second controller that instructs said engine to follow said map tables during use of said engine. The embodiment may further comprise a first map table representing a first operating mode and a second map table representing a second operating mode or condition. Additionally the embodiment may have a main fuel injector capable of directly injecting a second gaseous fuel into said combustion chamber, and a pilot fuel injector capable of injecting a pilot fuel into said combustion chamber. The embodiment may further comprise an intake conduit for directing said natural gas fuel into said combustion chamber and an array having a natural gas injector configured to inject natural gas into said intake conduit, wherein the natural gas is introduced into said combustion chamber of said engine with a primary fuel and air.

An embodiment of a system for using natural gas in combination with diesel fuel for combustion in an engine may comprise:

an engine;

a tank of natural gas;

a tank of diesel fuel;

a depressurization chamber; and

an injection assembly for injecting metered natural gas into an air take of the engine.

An embodiment of a method for using natural gas in combination with diesel fuel for combustion in an engine may comprise:

depressurizing natural gas from a pressurized state;

mixing said natural gas with air in an air in take to an engine;

supplying diesel fuel to said engine; and

supplying natural gas to said engine, such that said natural gas and said diesel fuel are mixed in a predetermined ratio thereby optimizing efficiency.

An embodiment of a network for maximizing efficiency of the operation of network members may comprise:

a first data set relating to operational conditions of network members;

a second data set identifying network members;

a third data set comprising optimizational information and parameters;

wherein the first data set, the second data set and the third data set are stored on a server connected to the network.

An embodiment of a method of use may perform the step of sensing and recording operational data from said engine to computer readable memory, wherein said operational data comprises engine speed, engine load, mass flow into said engine. The embodiment may further perform the step of processing with a first computer processor said operational data to create operational map tables for said engine and writing said operational map tables to computer readable memory. Additionally, an embodiment may perform the step of instructing a second computer processor that is in communication with said engine to retrieve from memory said operational map tables for controlling engine operation with the second computer processor based on values retrieved from said operational map tables during use. The embodiment may further include the steps of generating a first instruction from a first map table during a portion of use, and generating a second instruction from a second map table during a portion of use. The method may further include controlling a main fuel injector capable of directly injecting a second gaseous fuel into a combustion chamber and controlling a pilot fuel injector capable of injecting a pilot fuel into said combustion chamber, such that directing said natural gas fuel into said combustion chamber by controlling an array having a natural gas injector configured to inject natural gas in to said intake conduit, wherein the natural gas is introduced into said combustion chamber of said engine with a primary fuel and air.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited in each claim. Rather, inventive aspects lie in less than all features of a single foregoing disclosed embodiment.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An apparatus for introducing fuel into a combustion chamber of an internal combustion engine comprising:
a plurality of sensors for collecting operational data from the engine, wherein said operational data comprises engine speed, engine load, and mass flow into said engine;
a first controller that processes said operational data to create operational map tables for said engine;
a second controller that instructs said engine to follow said map tables during use of said engine;
a first map table representing a first operating condition;
a second map table representing a second operating condition;
a main fuel injector capable of directly injecting a second gaseous fuel into said combustion chamber;
a pilot fuel injector capable of injecting a pilot fuel into said combustion chamber;
an intake conduit for directing said natural gas fuel into said combustion chamber;
an array having a natural gas injector configured to inject natural gas into said intake conduit; and
wherein the natural gas is introduced into said combustion chamber of said engine with a primary fuel and air.

2. The apparatus of claim 1 further comprising a port for introducing natural gas located behind a turbo such that said natural gas is injected after the turbo has increased the pressure within said intake conduit.

3. The apparatus of claim 2 further comprising a pressure reducer to reduce the pressure of the natural gas within the apparatus.

4. The apparatus of claim 2, wherein said array contains a pair of natural gas injectors configured to work independently from one another.

5. The apparatus of claim 4, wherein the natural gas injectors are configured to inject natural gas independently at intervals corresponding to one of said first and second map tables.

6. The apparatus of claim 4, wherein said pair of natural gas injectors independently operate, such that their intervals of injection overlap that of the other.

7. The apparatus of claim 2 further comprising a temperature sensor that senses the temperature of air and fuel after being pressurized by the turbo.

8. The apparatus of claim 2 further comprising a temperature sensor that senses exhaust gas temperature after combustion.

9. The apparatus of claim 2, wherein said second controller electronically communicates with the first controller and influences control instructions issued by said first controller.

10. The apparatus of claim 2, wherein said second controller is electronically isolated from the first controller.

11. The apparatus of claim 9, wherein said second map table includes operational instructions for an apparatus that is loaded at a first load.

12. The apparatus of claim 11, wherein the first map table includes instructions comprising operational instructions for an apparatus that is loaded at a second load.

13. The apparatus of claim 1 further comprising a port for introducing natural gas that is physically located before a turbo, such that said natural gas is injected before the turbo has increased the pressure within said intake conduit.

14. The apparatus of claim 13 further comprising a pressure reducer to reduce the pressure of the natural gas within the apparatus.

15. The apparatus of claim 13, wherein said array contains a pair of natural gas injectors configured to work independently from one another.

16. The apparatus of claim 15, wherein the natural gas injectors are configured to inject natural gas independently at intervals corresponding to one of said first and second map tables.

17. The apparatus of claim 15, wherein said pair of natural gas injectors independently operate, such that their intervals of injection overlap that of the other.

18. The apparatus of claim 13 further comprising a temperature sensor that senses the temperature of air and fuel after being pressurized by the turbo.

19. The apparatus of claim 13 further comprising temperature sensor that senses exhaust gas temperature after combustion.

20. The apparatus of claim 13, wherein said second controller electronically communicates with the first controller and influences control instructions issued by said first controller.

21. The apparatus of claim 13, wherein said second controller is electronically isolated from the first controller.

22. The apparatus of claim 9, wherein said second map table includes operational instructions for an apparatus that is loaded at a first load.

23. The apparatus of claim 11, wherein the first map table includes instructions comprising operational instructions for an apparatus that is loaded at a second loading.

24. The apparatus of claim 1, wherein the line distance between said natural gas injector and a port into an intake is predetermined based on an interval of natural gas injections.

25. The apparatus of claim 24, wherein the line distance between said natural gas injector and said port into an intake is within a range of about one foot and about six feet.

26. A method for introducing fuel into a combustion chamber of an internal combustion engine comprising:
sensing and recording operational data from said engine to computer readable memory, wherein said operational data comprises engine speed, engine load, mass flow into said engine;
processing with a first computer processor said operational data to create operational map tables for said engine and writing said operational map tables to computer readable memory;
instructing a second computer processor that is in communication with said engine to retrieve from memory said operational map tables for controlling engine operation with the second computer processor based on values retrieved from said operational map tables during use;
generating a first instruction from a first map table during a portion of use;
generating a second instruction from a second map table during a portion of use;
controlling a main fuel injector capable of directly injecting a second gaseous fuel into a combustion chamber;
controlling a pilot fuel injector capable of injecting a pilot fuel into said combustion chamber;
directing said natural gas fuel into said combustion chamber by controlling an array having a natural gas injector configured to inject natural gas in to said intake conduit, wherein the natural gas is introduced into said combustion chamber of said engine with a primary fuel and air.

27. The method of claim 26 further comprising injecting natural gas behind a turbo that is configured to increase pressure.

28. The method of claim 26 further comprising reducing the pressure of the natural gas within the apparatus.

29. The method of claim 26 further comprising controlling a pair of natural gas injectors configured to work independently from one another.

30. The apparatus of claim 29 further comprising controlling the natural gas injectors to inject independently at intervals corresponding to one of said map tables.

31. The apparatus of claim 29 further comprising said pair of natural gas injectors independently operate such that their intervals of injection overlap that of the other.

32. The apparatus of claim 26 further comprising sensing a temperature of air and fuel after being pressurized by the turbo.

33. The apparatus of claim 26 further comprising sensing exhaust gas temperature after combustion.

34. The apparatus of claim 26, wherein the second computer processor electronically communicates with the first computer processor to influence control instructions issued by said first computer processor.

35. An apparatus for introducing fuel into a combustion chamber of an internal combustion engine comprising:
a plurality of sensors for collecting operational data from the engine, wherein said operational data comprises engine speed, engine load, and mass flow into said engine;
a first controller that processes said operational data to create operational map tables for said engine;
a second controller that instructs said engine to follow said map tables during use of said engine;
a first map table representing a first operating mode;
a second map table representing a second operating mode;
a main fuel injector capable of directly injecting a second gaseous fuel into said combustion chamber;
a pilot fuel injector capable of injecting a pilot fuel into said combustion chamber;
an intake conduit for directing said natural gas fuel into said combustion chamber;
an array having a natural gas injector configured to inject natural gas into said intake conduit; and
a network component for communicates across a network for optimizing said map tables.
